(19) United States
(12) Patent Application Publication
(10) Pub. No.: US 2009/0191384 A1
(43) Pub. Date: Jul. 30, 2009

(54) POLYETHYLENE BACKBOARD TRAINING DEVICE

(76) Inventor: Tilford C. Jones, Ijamsville, MD (US)

Correspondence Address: MANELLI DENISON & SELTER, 2000 M STREET NW SUITE 700, WASHINGTON, DC, 20036-3307, US

(21) Appl. No.: 12/022,295

(22) Filed: Jan. 30, 2008

(51) Int. Cl. B32B 3/10; B44C 1/22; B29C 47/04; A63B 69/00

(52) U.S. Cl. 428/195.1; 264/139; 473/435

(57) ABSTRACT

A high density polyethylene panel suitable for use in a backboard training device.

### FIELD OF THE INVENTION

The invention relates high density polyethylene (HDPE) panels suitable for use in a backboard training device.

### BACKGROUND OF THE INVENTION

A variety of sports utilize backboard training for practice and conditioning. Tennis players develop stroke technique, footwork and stamina. Soccer, Lacrosse, and basketball players likewise utilize the rebound of backboards to develop skills specific to their sports. The innate simplicity of a backboard belies its ability to provide both introductory through advanced level skill development in numerous sports.

Backboard practice can take place against a garage door or any flat wall. Plywood and concrete block is often used to fashion backboards. However, both such products require constant maintenance. Wood requires painting, sealing and flashing to prevent rot and warping. Block is expensive to build and needs painting, caulking, parging and pointing.

Backboard training is so popular that a number of companies have introduced panelized backboard products to the market place. These products are generally sold in custom paneled increments of 4 feet wide by 8 feet or 10 feet in height. The panels are normally attached to an existing fence structure or other support poles. The more panels you buy, the wider your backboard can be.

Backboard kits are available with plywood panels, MDO panels, fiberglass panels, vacuum molded or otherwise molded plastic panels or painted-treated drywall panels.

All of the above systems have limitations and problems.

Fiberglass, vacuum molded and injection molded panels are subject to damage when used for Lacrosse or Soccer Practice. The balls used in these sports can puncture or crack the panels ruining the product. Fiberglass backboards utilize a thin, painted-on surface that is subject to U.V degradation and often develops dead spots.

Plywood and MDO Board panels are subject to rotting, warping, delamination and require constant painting, sealing and flashing.

HDPE panels are very difficult to mark with permanent target markings, such as tennis net lines, lacrosse goal outlines, etc., because paint and adhesives do not stick to the surface. Furthermore, I have attempted to bolt, rivet, and/or screw markings on the panel, such as aluminum strips, plastic strips and polyestervinyl strapping. However, all attempts at applying permanent target markings to the HDPE panels have failed, because the markings buckled as the panels expanded and contracted during ambient temperature changes.

### SUMMARY OF THE INVENTION

An objective of the invention is to provide HDPE panels that are suitable for use in a backboard training device that is low maintenance, such that it is not prone to rotting, warping, or delamination and does not require constant painting, sealing and flashing.

Another objective of the invention is to solve the problems associated with providing permanent target markings on HDPE panels.

The above objectives and other objectives are obtained by an HDPE panel comprising a surface layer and at least one other layer bonded to the surface layer, the surface layer and the at least one other layer having different colors, and at least one permanent marking formed by removing the surface layer in the shape of the marking to expose the color of the at least one other layer.

The above objectives are also obtained by a backboard training device comprising a plurality of HDPE panels, each HDPE panel comprising a surface layer and at least one other layer bonded to the surface layer, the surface layer and the at least one other layer having different colors, and at least one permanent marking formed by removing the surface layer in the shape of the marking to expose the color of the at least one other layer, wherein the other layer and surface layer are coextruded.

### BRIEF DESCRIPTION OF THE DRAWINGS

FIG. 1 illustrates a frontal view of an HDPE panel;

FIG. 2 illustrates a side view of an HDPE panel; and

FIG. 3 illustrates a backboard training device comprising a plurality of HDPE panels.

### DETAILED DESCRIPTION OF THE INVENTION

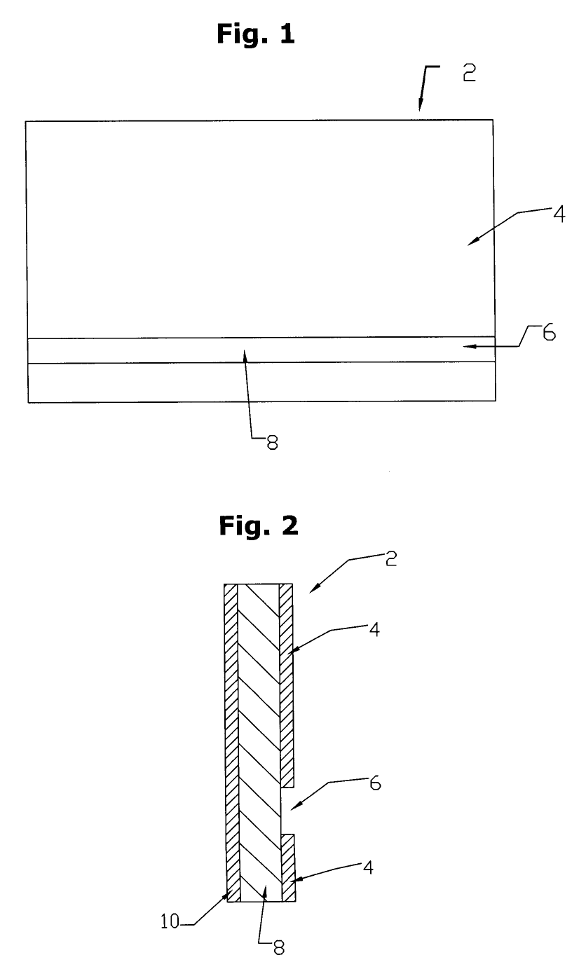

The invention will now be explained with reference to the attached Figs., without being limited thereto. FIG. 1 shows a front view of an exemplary HDPE panel 2 having a surface layer 4 in one color and an other layer 8 having a second color. The HDPE panel 2 has marking 6 in the shape of a line engraved in the surface 4 so the second color of the other layer 8 is exposed. FIG. 2 is a side view of the HDPE panel 2 having a surface 4 in one color and a marking 6 in the shape of a line engraved in the surface layer 4 so the second color of the other layer 8 is exposed. FIG. 2 also shows an optional third layer 10.

The thickness of the surface layer 4 can be as desired. The surface layer 4 should be sufficiently thick so that any wear marks from use do not show the color of the other layer 8. Preferably the thickness of the surface layer 4 is about ¼ inch or less, most preferably about ⅛ inch or less.

The HDPE panels are typically sized at about 4 feet by 8 feet or 4 feet by 10 feet. However, any desired size can be produced. The thickness of the HDPE panels should be selected to provide a desired level of rigidity during use. Typically, a thickness from about 0.5 inch to about 2 inches, preferably about 0.7 to about 1.5 inches, is sufficient. If the panels are too thick, then weight and higher cost may become a problem. If the panels are too thin, they may undesirably flex during use.

The HDPE panels can withstand the impact of lacrosse balls, soccer balls, baseballs and soccer balls without being punctured, split or otherwise damaged. The HDPE panels are highly immune to degradation or damage due to drastic temperature variations, weather or air pollution conditions.

HDPE materials are now well known. Thus, the HDPE material can be selected as desired. Formation of panels using extrusion methods are also now well known. Those skilled in the art will easily be able to use known manufacturing methods to form the novel HDPE panels described herein. While the different layers of the HDPE panels can be bonded using any desired method, preferably the layers are coextruded.

Coloration of HDPE materials by addition of pigments is also well known. Using the description provided herein, one skilled in the art will be able to use known methods to coextrude the novel HDPE panels having different colored layers.

Preferably, the HDPE material includes ultra-violet inhibitors to reduce damage caused by sunlight.

The markings 6 can be in any shape as desired. Non-limiting examples a markings 6 are tennis net lines and target markings, such as a Lacrosse Goal or Soccer Goal, engraved into the panel, thus, providing a permanent, no-maintenance feature.

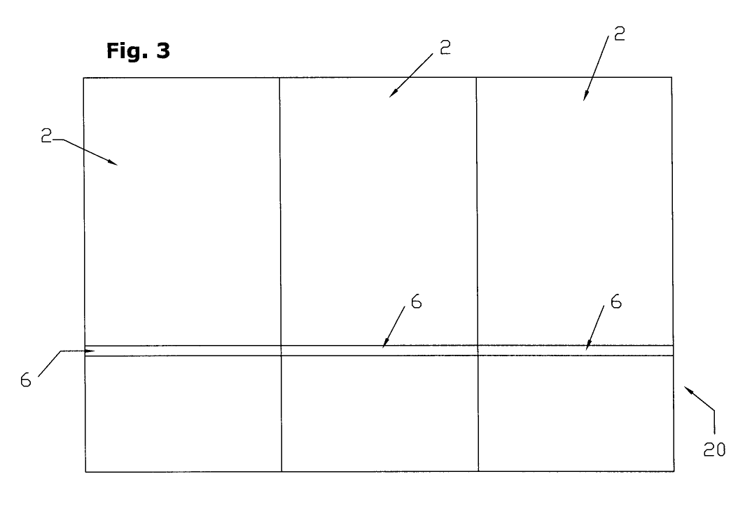

The HDPE panels can be used in a backboard training device by mounting a plurality of them to a rigid support. Preferably, a movable mount is utilized to avoid buckling due to expansion and contraction. My earlier filed U.S. Patent Application No. 60/990,974, filed 29 Nov. 2007, describes in detail how the HDPE panels can be mounted and used in a backboard training device, the complete disclosure of which is incorporated herein by reference. An example of a backboard training 20 device utilizing multiple HDPE panels 2 is shown in FIG. 3, having the markings 6 lined up to form a tennis net line.

If the panels are to be used as a tennis training backboard, preferably, the surface layer 4 is colored green and the other layer 8 is colored white, so that white lines representing the net and/or out of bounds are clearly defined.

Example of HDPE Panel

A non-limiting example of a HDPE panel has a width of about 4 feet, a height of about 8 or 10 feet, and a thickness of about ¾ inch. The HDPE panel has a coefficient of expansion of about 0.000067 in/in ° F.

Preferred Thermal Expansion & Contraction Coefficients for: 48″ Wide HDPE Backboard Panels
Note: Provides maximum a and durability in all tested U.S. Climates when mounted in accordance with the enclosed, specified mounting systems.

| Thermal expansion of contraction | | 0.000067 in/in F. | | |
|---|---|---|---|---|
| coefficient | | | | |
| Sheet Length (inches) and | | All for 48″ wide panelled increments | | |
| contraction/expansion (inches) | | | | |
| | Temperature Differential (F.) | 96 | 120 | 144 |
| | 5 | 0.0322 | 0.0402 | 0.0482 |
| | 10 | 0.0643 | 0.0804 | 0.0965 |
| | 15 | 0.0965 | 0.1206 | 0.1447 |
| | 20 | 0.1286 | 0.1608 | 0.1930 |
| | 25 | 0.1608 | 0.2010 | 0.2412 |
| | 30 | 0.1930 | 0.2412 | 0.2894 |
| | 35 | 0.2251 | 0.2814 | 0.3377 |
| | 40 | 0.2573 | 0.3216 | 0.3859 |
| | 45 | 0.2894 | 0.3618 | 0.4342 |
| | 50 | 0.3216 | 0.4020 | 0.4824 |
| | 55 | 0.3538 | 0.4422 | 0.5306 |
| | 60 | 0.3859 | 0.4824 | 0.5789 |
| | 65 | 0.4181 | 0.5226 | 0.6271 |
| | 70 | 0.4502 | 0.5628 | 0.6754 |
| | 75 | 0.4824 | 0.6030 | 0.7236 |
| | 80 | 0.5146 | 0.6432 | 0.7718 |
| | 85 | 0.5467 | 0.6834 | 0.8201 |
| | 90 | 0.5789 | 0.7236 | 0.8683 |
| | 95 | 0.6110 | 0.7638 | 0.9166 |
| | 100 | 0.6432 | 0.8040 | 0.9648 |
| | 105 | 0.6754 | 0.8442 | 1.0130 |
| | 110 | 0.7075 | 0.8844 | 1.0613 |
| | 115 | 0.7397 | 0.9246 | 1.1095 |
| | 120 | 0.7718 | 0.9648 | 1.1578 |
| | 125 | 0.8040 | 1.0050 | 1.2060 |

While the claimed invention has been described in detail and with reference to specific embodiments thereof, it will be apparent to one of ordinary skill in the art that various changes and modifications can be made to the claimed invention without departing from the spirit and scope thereof.

1. An HDPE panel comprising a surface layer and at least one other layer bonded to the surface layer, the surface layer and the at least one other layer having different colors, and at least one permanent marking formed by removing the surface layer in the shape of the marking to expose the color of the at least one other layer.

2. The HDPE panel according to claim 1, wherein the surface layer is green, the other layer is white, and the marking comprises at least one line.

3. The HDPE panel according to claim 1, wherein the surface layer and other layer are formed by coextrusion.

4. The HDPE panel according to claim 1, wherein the panel is about 4 feet by 8 feet.

5. The HDPE panel according to claim 1, wherein the panel is about 4 feet by 10 feet.

6. The HDPE panel according to claim 1, wherein the thickness of the panel is about 0.5 inch to about 2 inches.

7. The HDPE panel according to claim 1, wherein the marking is a net line, the color of the surface layer is green and the color of the other layer is white.

8. The HDPE panel according to claim 1, wherein the markings are in the shape and size of a lacrosse goal outline.

9. The HDPE panel according to claim 1, wherein the markings and in the shape of a tennis net line.

10. A backboard training device comprising a plurality of HDPE panels mounted to a support, at least one HDPE panel comprising a surface layer and at least one other layer bonded to the surface layer, the surface layer and the at least one other layer having different colors, at least one permanent marking formed by removing the surface layer in the shape of the marking to expose the color of the at least one other layer.

11. The backboard training device according to claim 10, wherein the HDPE panels are mounted so that the markings on the panels line up to form a tennis net line.

12. The backboard training device according to claim 10, wherein the HDPE panels are mounted so that the markings are in the shape and size of a lacrosse goal outline.

13. The backboard training device according to claim 10, wherein the surface layer is green, the other layer is white, and the marking comprises at least one line.

14. The backboard training device according to claim 10, wherein the surface layer and other layer are formed by coextrusion.

15. The backboard training device according to claim 10, wherein the at least one panel is about 4 feet by 8 feet.

16. The backboard training device according to claim 10, wherein the at least one panel is about 4 feet by 10 feet.

17. The backboard training device according to claim 10, wherein the thickness of the at least one panel is about 0.5 inch to about 2 inches.

18. The backboard training device according to claim 10, wherein the marking is a tennis net line, the color of the surface layer is green and the color of the other layer is white.

19. The backboard training device according to claim 10, wherein the panels are movably mounted to the support.

20. A method of making a backboard training device comprising;
forming an HDPE panel by coextruding at least two different color layers to form a surface layer having a different color than an other layer, wherein the HDPE panel has a thickness of about 0.5 to about 2 inches;
shaping the HDPE panel to have a width of about 4 feet and a desired length; and
engraving the panel to remove a portion of the surface layer and expose the color of the other layer to provide a permanent marking in the shape of the removed surface layer.
